(19) United States
(12) Patent Application Publication
(10) Pub. No.: US 2007/0112970 A1
(43) Pub. Date: May 17, 2007

(54) Data communication server, data communication method, and program

(75) Inventors: Hideto Kihara, Kawasaki (JP); Kazuki Matsui, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/589,743

(22) Filed: Oct. 31, 2006

(30) Foreign Application Priority Data
Nov. 15, 2005 (JP) 2005-330749

(51) Int. Cl. G06F 15/16

(52) U.S. Cl. 709/230

(57) ABSTRACT

A data communication server capable of communicating data with a plurality of portable terminals through a communication line includes a terminal information acquiring part for acquiring terminal data that represents the amount of transmission standby data and a data transmission efficiency, regarding each of the plurality of portable terminals, a priority calculating part for calculating a priority of data transmission in each of the plurality of portable terminals, based the terminal data, a condition generating part for generating transmission condition data on data transmission between a portable terminal and the data communication server, based on the priority, and a data transmitting part for receiving the reception standby data from the portable terminal, based on the transmission condition data. The data communication server enables efficient data transmission in accordance with the communication state between a plurality of portable terminals and the data communication server.

### BACKGROUND OF THE INVENTION

1. Field of the Invention

The present invention relates to a data communication server capable of communicating data with a plurality of portable terminals through a communication line, a data communication method, and a program. In particular, the present invention relates to a data communication server that receives an upload of a large amount of data from a number of portable terminals and transmits data to a number of portable terminals via a mobile communication line.

2. Description of Related Art

Recently, a wireless local area network (LAN) and a mobile telephone having a data communication function are proliferating, and a wireless network is becoming widespread in addition to a conventional network of data communication via a wired LAN. Furthermore, mounting a digital camera on a mobile telephone and a personal digital assistant (PDA)/hand held terminal (HHT) is also becoming popular. Along with this, a system has come on, which enables a working spot and an article appearance photographed by a camera to be transmitted to a server as still image or moving image data, and utilized in an operation.

Conventionally, it has been assumed that various kinds of operation applications using a network mainly use a fixed terminal such as a personal computer in an environment that is connected to a wired LAN at all times, as a data communication target. However, recently, there is a demand for an operation application that uses a portable terminal in a mobile communication (wireless communication between mobiles) environment such as a mobile telephone network or a wireless LAN, as a data communication target.

In the mobile communication environment, the situation of a radio wave changes along with the movement of a portable terminal, which causes a packet loss and communication disconnection. This is a situation that may be determined to be “abnormal” in a normally connected environment, and “may occur at all times” in a mobile communication environment.

Under present circumstances, communication error processing with respect to a packet loss, communication disconnection, and the like is performed in each operation application. The necessity of such communication error processing is a burden in the development of a front operation system in which a user directly performs an operation. Therefore, it is indispensable to develop a technique of making messaging processing (i.e., data communication) in a mobile communication environment stable and efficient.

Conventionally, in a system that uploads data from a number of terminals to a server, as a method for each terminal to upload, there are the following two methods, for example. In any of the methods, an upload may take much time in some cases. In one method, an upload time is previously defined for each terminal, and an upload is performed in accordance with the defined fixed schedule. According to this method, at a time of upload failure, a terminal waits until a subsequent defined time, and performs an upload again, so that a wait time becomes long. Furthermore, in a mobile communication environment, a connection state changes remarkably. Therefore, even if conditions such as an upload timing are optimized by a fixed schedule, when the connection state changes, the conditions may not be optimum any longer.

In the other method, a terminal that has failed in an upload attempts to perform an upload again at a time interval. According to this method, respective terminals perform an upload again at various time intervals when they fail in an upload, so that a useless wait time may occur.

As the technique of making data communication stable and efficient, for example, JP 2004-320159 A shows a method for performing quality of service (QoS) at each portable terminal. According to this method, for example, a QoS controller provided at each portable terminal controls QoS such as traffic adjustment among portable terminals, operation monitoring, and packet re-scheduling.

However, according to the above method, although one-to-one data communication between a portable terminal and another portable terminal is controlled, and multiple-to-one data communication as in the data communication between a number of portable terminals and the server is not controlled. Therefore, for example, in multiple-to-one data communication such as the upload from a number of portable terminals, it is difficult to perform data communication that is efficient as a whole, considering the communication state of a plurality of portable terminals.

### SUMMARY OF THE INVENTION

Therefore, with the foregoing in mind, it is an object of the present invention to provide a data transmission system, a data transmission method, and a program enabling efficient data transmission in accordance with the communication state between a plurality of portable terminals and a data communication server.

A data communication server according to the present invention capable of communicating data with a plurality of portable terminals through a communication line includes: a terminal information acquiring part for acquiring terminal data that represents an amount of transmission or reception standby data and a data transmission efficiency with respect to the data communication server, regarding each of the plurality of portable terminals; a priority calculating part for obtaining a predicted time taken for the transmission or reception standby data to be transmitted or received, with respect to each of the plurality of portable terminals, using the amount of the transmission or reception standby data and the data transmission efficiency, and calculating a priority of data transmission in each of the plurality of portable terminals, using the predicted times of the plurality of portable terminals; a condition generating part for generating transmission condition data that represents a period of time of data transmission and a transmission data amount between at least one of the plurality of portable terminals and the data communication server, based on the priority; and a data transmitting part for transmitting the transmission standby data to a portable terminal or receiving the reception standby data from the portable terminal, based on the transmission condition data.

The terminal data represents the communication state between each of the plurality of portable terminals and the data communication server by the amount of the transmission or reception standby data and the data transmission efficiency. The priority calculating part calculates a priority using the terminal data, so that it can specify a portable terminal whose data transmission is to be prioritized in accordance with the communication state of the plurality of portable terminals. Furthermore, the priority calculating part calculates a priority considering not only the communication state between one portable terminal and the data communication server, but also the communication state between the plurality of portable terminals and the data communication server. Therefore, the condition generating part can generate transmission condition data for realizing optimum data transmission considering the communication state between the plurality of portable terminals and the data communication server based on the priority. Data is transmitted between the plurality of portable terminals and the data communication server based on the transmission condition data, whereby efficient data transmission can be performed in accordance with the communication state between the plurality of portable terminals and the data communication server.

In the data communication server according to the present invention, it is preferable that the priority calculating part calculates a priority so as to most prioritize data transmission of a portable terminal with a longest predicted time among the plurality of portable terminals.

According to the above configuration, the priority of data transmission of a portable terminal to be a bottleneck in data transmission by the plurality of portable terminals due to the predicted time longer than those of the other portable terminals is calculated to be higher than those of the other portable terminals. Consequently, transmission condition data that prioritizes the data transmission between the portable terminal to be a bottleneck and the data communication server is generated in the condition generating part. Each portable terminal and the data communication server perform data transmission based on the transmission condition data, whereby the data transmission of the portable terminal to be a bottleneck can be prioritized. Because of this, the data transmission between the plurality of portable terminals and the data communication server is completed at an early stage as a whole.

In the data communication server according to the present invention, it is preferable that the terminal information acquiring part acquires terminal data containing data that represents a radio wave intensity of a portable terminal, and the priority calculating part obtains the predicted time, further using the radio wave intensity.

According to the above configuration, the priority calculating part can reflect a line disconnection risk based on a radio wave intensity onto the priority. Consequently, the communication state whose change between the portable terminal and the data communication server is remarkable can be formed into data as a priority. Because of this, the condition generating part can generate more appropriate transmission condition data.

In the data communication server according to the present invention, it is preferable that the terminal information acquiring part acquires the terminal data, in a case where the amount of the transmission or reception standby data or the data transmission efficiency changes by a predetermined amount compared with that at a previous acquisition in a portable terminal.

Because of this, the terminal information acquiring part can dynamically acquire terminal data in accordance with the communication state of a portable terminal. Therefore, a priority and transmission condition data are calculated at any time in accordance with the connection state between the portable terminal and the data communication server, and the change in the state of the portable terminal.

A portable terminal according to the present invention capable of communicating data with the data communication server according to the present invention through a communication line includes: a terminal information transmitting part for transmitting terminal data that represents an amount of transmission standby data from the portable terminal and a data transmission efficiency with respect to the data communication server, to the data communication server; a condition receiving part for receiving transmission condition data that represents a period of time of data transmission and a data transmission amount with respect to the data communication server, from the data communication server; and a data transmitting part for transmitting the transmission standby data to the data communication server, based on the transmission condition data.

The terminal information transmitting part transmits terminal data to the data communication server, whereby the amount of transmission standby data and a data transmission efficiency that change at a portable terminal are transmitted to the data communication server. The data communication server generates transmission condition data of the portable terminal and transmits it to the portable terminal, considering the terminal data of the other portable terminals. The condition receiving part of the portable terminal receives the transmission condition data. The data transmitting part transmits transmission standby data to the data communication server based on the transmission condition data. Therefore, efficient data transmission also considering the communication states of the other portable terminals is performed.

A data communication method according to the present invention for a data communication server to transmit/receive data with respect to a plurality of portable terminals through a communication line includes: an operation in which a terminal information acquiring part of the data communication server acquires terminal data that represents an amount of transmission or reception standby data and a data transmission efficiency with respect to the data communication server, regarding each of the plurality of portable terminals; an operation in which a priority calculating part of the data communication server obtains a predicted time taken for the transmission or reception standby data to be transmitted or received, with respect to each of the plurality of portable terminals, using the amount of the transmission or reception standby data and the data transmission efficiency, and calculates a priority of data transmission in each of the plurality of portable terminals, using the predicted times of the plurality of portable terminals; an operation in which a condition generating part of the data communication server to generate transmission condition data that represents a period of time of data transmission and a data transmission amount between at least one of the plurality of portable terminals and the data communication server, based on the priority; and an operation in which a data transmitting part of the data communication server transmits the transmission standby data to a portable terminal or receives the reception standby data from the portable terminal, based on the transmission condition data.

A program stored in a recording medium according to the present invention causes a computer to execute processing of generating a condition when a data communication server transmits/receives data with respect to a plurality of portable terminals through a communication line. The processing includes: terminal information acquiring processing of acquiring terminal data that represents an amount of transmission or reception standby data and a data transmission efficiency with respect to the data communication server, regarding each of the plurality of portable terminals; priority calculating processing of obtaining a predicted time taken for the transmission or reception standby data to be transmitted or received, with respect to each of the plurality of portable terminals, using the amount of the transmission or reception standby data and the data transmission efficiency, and calculating a priority of data transmission in each of the plurality of portable terminals, using the predicted times of the plurality of portable terminals; and condition generating processing of generating transmission condition data that represents a period of time of data transmission and a data transmission amount between at least one of the plurality of portable terminals and the data communication server, based on the priority.

According to the present invention, a data transmission system, a data transmission method, and a program can be provided, which enable efficient data transmission in accordance with the communication state between a plurality of portable terminals and a data communication server.

These and other advantages of the present invention will become apparent to those skilled in the art upon reading and understanding the following detailed description with reference to the accompanying figures.

### BRIEF DESCRIPTION OF THE DRAWINGS

FIG. 1 is a schematic diagram of portable terminals, a mobile communication line, and a data communication server.

FIG. 2 is a functional block diagram showing exemplary configurations of the data communication server and the portable terminal.

FIG. 3 shows an exemplary data structure of terminal data and a priority.

FIG. 4 is a sequence diagram showing exemplary processing in the data communication server and the portable terminal.

FIG. 5 is a flowchart showing exemplary processing for a priority calculating part to calculate a priority.

FIG. 6 schematically shows a period of time from a current time to a transmission start, and a processing expected time in portable terminals.

FIG. 7 is a diagram illustrating an example of the effect by the data communication server.

### DETAILED DESCRIPTION OF THE INVENTION

Hereinafter, the present invention will be described in detail by way of one embodiment with reference to the drawings.

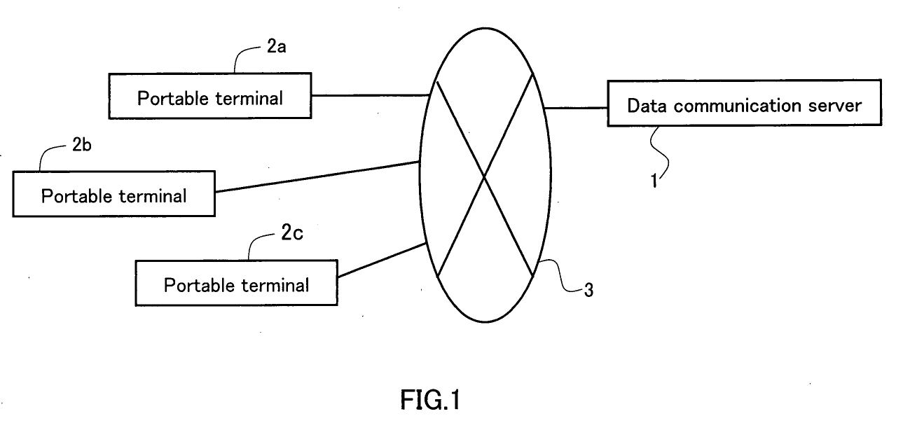

In the present embodiment, an exemplary data communication server that uploads a large amount of data from a number of portable terminals to a server via a mobile communication line will be described. FIG. 1 is a schematic diagram showing portable terminals, a mobile communication line, and a data communication server. As shown in FIG. 1, a data communication server 1 is in a state capable of communicating data with a plurality of portable terminals 2a, 2b, 2c through a mobile communication line 3. In FIG. 1, for simplicity of the description, although only three portable terminals capable of communicating data with the data communication server 1 are shown, a larger number of portable terminals can actually communicate with the data communication server 1.

The data communication server 1 is used for, for example, an operation system that collects data from the portable terminals 2a, 2b, 2c at a plurality of sales offices, or the like. The portable terminals 2a, 2b, 2c are, for example, those which are capable of performing wireless communication, such as a mobile telephone, a PDA, an HHT, a notebook personal computer, a tablet-type personal computer, a portable game machine, a portable digital audio player, a portable digital video player, and a digital camera. A mobile communication line 3 includes, for example, a wireless communication network such as a wireless LAN, a mobile communication network, WiMAX, Bluetooth, UWB, ZigBee, wireless FireWire, or IrDA.

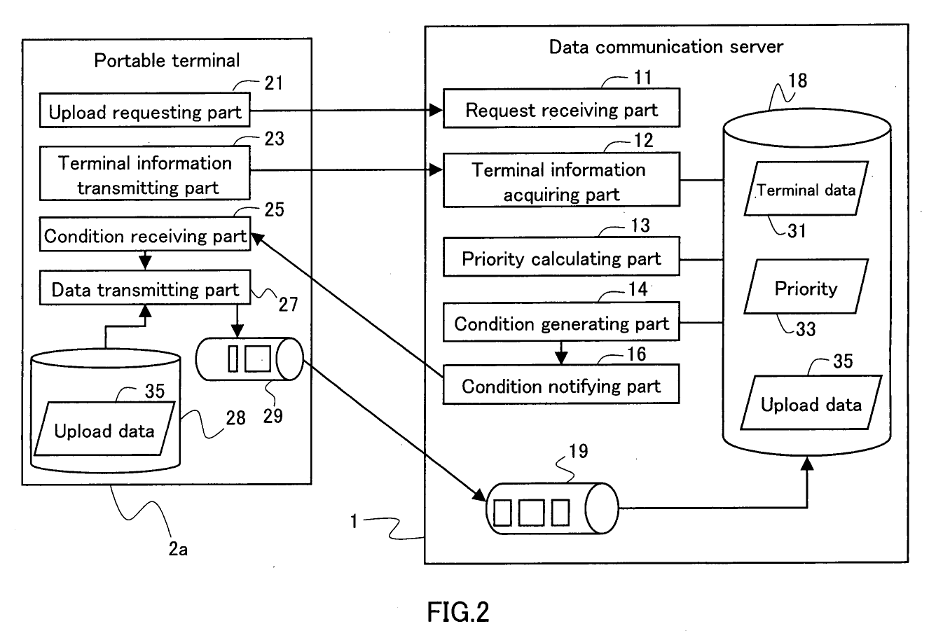

FIG. 2 is a functional block diagram showing exemplary configurations of the data communication server 1 and the portable terminal 2a. Herein, the configurations of the portable terminals 2b, 2c can also be set to be the same as that of the portable terminal 2a.

As shown in FIG. 2, the data communication server 1 includes a request receiving part 11, a terminal information acquiring part 12, a priority calculating part 13, a condition generating part 14, a condition notifying part 16, a recording part 18, and a receiving queue 19. The portable terminal 2a includes an upload requesting part 21, a terminal information transmitting part 23, a condition receiving part 25, a data transmitting part 27, a recording part 28, and a transmitting queue 29.

For example, in the case where upload data 35 in a transmission standby status is generated, when an upload becomes necessary, the upload requesting part 21 of the portable terminal 2a requests an upload with respect to the data communication server 1. The request receiving part 11 of the data communication server 1 receives an upload request from the portable terminal 2a.

The terminal information acquiring part 12 receives, for example, terminal data transmitted from the terminal information transmitting part 23 of the portable terminal 2a, and records it in the recording part 18. The terminal data 31 represents, for example, the amount of transmission standby data in the portable terminal 2a, and a data transmission efficiency between the portable terminal 2a and the data communication server 1. The terminal information acquiring part 12 receives terminal data transmitted from the other portable terminals 2b, 2c, in addition to the terminal data transmitted from the portable terminal 2a, and records them in the recording part 18.

Examples of the data representing a data transmission efficiency include an average transmission speed (bps), a maximum transmission speed (bps), a radio wave intensity, an average delay time, and a packet loss ratio. The data representing the amount of transmission standby data may represent the size of transmission standby data or may represent a change ratio of transmission standby data.

The priority calculating part 13 calculates a priority 33 for data transmission with respect to each of the portable terminals 2a, 2b, 2c based on the terminal data 31, and records the priority 33 in the recording part 18. The priority is represented by, for example, a numerical value, and as the numerical value is larger, the priority is higher.

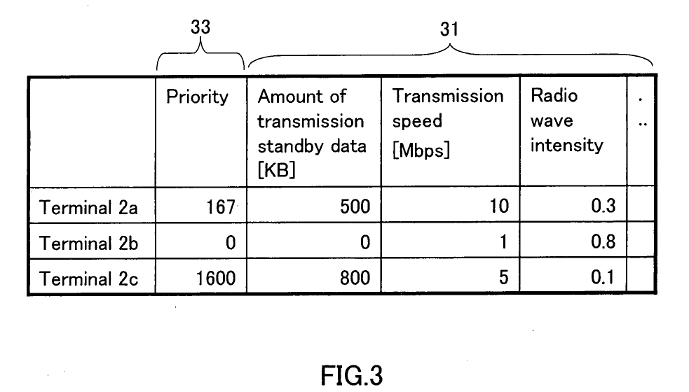

FIG. 3 shows an exemplary data structure of the terminal data 31 and the priority 33 recorded in the recording part 18. In the example shown in FIG. 3, at least a priority, the amount of transmission standby data, a transmission speed (Mbps), and a radio wave intensity are recorded with respect to each of the portable terminals 2a, 2b, 2c.

The condition generating part 14 generates transmission condition data with respect to each of the portable terminals 2a, 2b, 2c based on the priority 33 recorded in the recording part 18. The transmission condition data represents, for example, a period of time for data transmission and the amount of transmission data between the data communication server 1 and the portable terminal 2a. The transmission condition data represents, for example, a timing for the portable terminal 2a to upload data, and an upload method. The transmission condition data contains, for example, a transmission start time, a transmission interval, the size of one message, the number of connections, and the like.

The condition notifying part 16 transmits the transmission condition data generated by the condition generating part 14 to each of the portable terminals 2a, 2b, 2c.

The condition receiving part 25 of the portable terminal 2a receives the transmission condition data transmitted from the condition notifying part 16 of the data communication server 1. The transmission condition data received by the condition receiving part 25 is given to the data transmitting part 27.

The data transmitting part 27 transmits the upload data 35 in a transmission standby status recorded in the recording part 28 to the data communication server 1 based on the transmission condition data received by the condition receiving part 25. For example, the condition receiving part 25 retrieves the upload data 35 in a transmission standby status from the recording part 28 and puts it in the transmitting queue 29 at the transmission start time described in the transmission condition data. The transmitting queue 29 successively sends out the upload data 35 put in the transmitting queue 29 to the receiving queue 19. The receiving queue 19 successively records the received upload data 35 in the recording part 18.

The portable terminal 2a contains a computer. The functions of the upload requesting part 21 of the portable terminal 2a, the terminal information transmitting part 23, the condition receiving part 25, and the data transmitting part 27 can be realized when a CPU or an MPU of the computer provided in the portable terminal 2a executes a predetermined program. As the recording part 28 of the portable terminal 2a, for example, a semiconductor memory, a hard disk, a removable memory card, or the like provided in the portable terminal 2a can be used.

The data communication server 1 is composed of, for example, a computer such as a personal computer, a server, or the like (hereinafter, referred to as a PC or the like). The functions of the request receiving part 11, the terminal information acquiring part 12, the priority calculating part 13, the condition generating part 14, the condition notifying part 16, and the receiving queue 19 of the data communication server 1 can be realized when a CPU or an MPU of a computer executes a predetermined program. Furthermore, as the recording part 18, a hard disk, a semiconductor memory, a flexible disk, a DVD, or the like provided in the computer can be used.

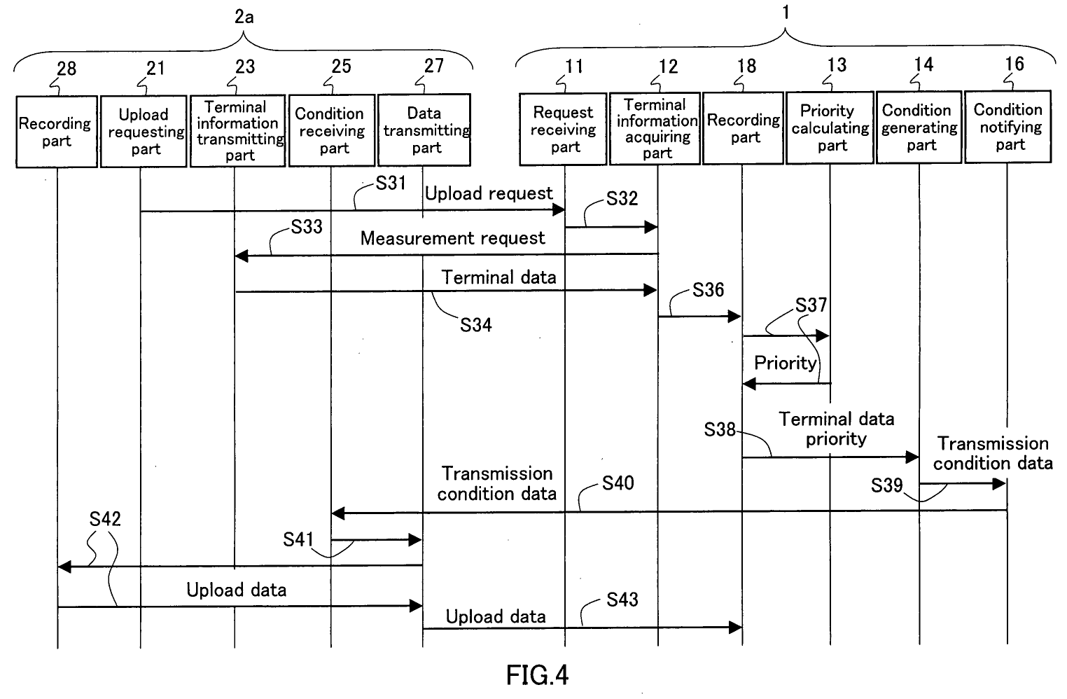

Next, the processing flow of the upload from the portable terminal 2a to the data communication server 1 will be described. FIG. 4 is a sequence diagram showing an example of processing in the data communication server 1 and the portable terminal 2a.

As shown in FIG. 4, first, the upload requesting part 21 of the portable terminal 2a transmits an upload request to the data communication server 1, and the request receiving part 11 receives the upload request (Op31). The upload requesting part 21 transmits the upload request to the data communication server 1, for example, when the upload data 35 in a transmission standby status is generated in the recording part 28 of the portable terminal 21.

The request receiving part 11 that has received the upload request gives information indicating that the upload request has been received to the terminal information acquiring part 12 (Op32). The terminal information acquiring part 12 transmits measurement requests to the portable terminals 2a, 2b, 2c (Op33). The terminal information transmitting part 23 of each of the portable terminals 2a, 2b, 2c receives the measurement request.

The terminal information transmitting part 23 transmits terminal data to the data communication server 1, upon receiving the measurement request (Op35). The terminal data contains, for example, the amount of the upload data 35 in a transmission standby status, the radio wave intensity of the portable terminal 2a, the average transmission speed and the maximum transmission speed between the portable terminal 2a and the data communications server 1, an average delay time, a packet loss ratio, and the like. The terminal data transmitted to the data communication server 1 is received by the terminal information acquiring part 12, and recorded in the recording part 18 as the terminal data 31 (Op36). The terminal data 31 has, for example, the data structure shown in FIG. 3.

The priority calculating part 13 calculates priorities of the respective portable terminals 2a, 2b, 2c based on the terminal data 31 in the recording part 18, and records them in the recording part 18 (Op37). The priority calculating part 13 obtains a predicted time, which is taken for the data in a transmission standby status in each of the portable terminals 2a, 2b, 2c to be transmitted, from the amount of transmission standby data, the transmission speed, and the radio wave intensity contained in the terminal data 31, with respect to each of the portable terminals 2a, 2b, 2c. The priority calculating part 13 calculates a priority of data transmission in each of the portable terminals 2a, 2b, 2c, using the predicted time in each of the portable terminals 2a, 2b, 2c. An example of the calculation processing of a priority will be described later.

The condition generating part 14 generates transmission condition data based on the terminal data 31 and the priority 33 recorded in the recording part 18, and gives it to the condition notifying part 16 (Op38). The condition generating part 14 generates transmission condition data that represents the condition of uploading the upload data 35 to the data communication server 1, with respect to the portable terminal 2a among the portable terminals 2a, 2b, 2c. The transmission condition data contains, for example, a transmission start time, the size of one message, the transmission interval of the respective messages, the number of connections, and the like. An example of the processing of generating the transmission condition data will be described later.

The condition generating part 14 gives the generated transmission condition data to the condition notifying part 16 (Op39). The condition notifying part 16 transmits the transmission condition data regarding the portable terminal 2a to the portable terminal 2a (Op40). The condition receiving part 25 of the portable terminal 2a receives the transmission condition data transmitted from the condition notifying part 16. The condition receiving part 25 gives the received transmission condition data to the data transmitting part 27 (Op41).

The data transmitting part 27 reads the upload data 35 in the recording part 28 based on the transmission condition data (Op42), and transmits it to the data communication server 1 (Op43). The data transmitting part 27, for example, divides the upload data 35 into the size of one message represented by the transmission condition data, and transmits them at a transmission interval represented by the transmission condition data from the transmission start time represented by the transmission condition data. Furthermore, connections in the number represented by the transmission condition data are established between the data transmitting part 27 and the data communication server 1, whereby the above transmission is performed. The upload data 35 transmitted by the data transmitting part 27 is recorded in the recording part 18 of the data communication server 1.

As described above, the upload data 35 is transmitted from the portable terminal 2a to the data communication server 1. The transmission processing in the above example is also performed in parallel with respect to the portable terminals 2b, 2c. More specifically, every time an upload request is transmitted from the portable terminal 2a, 2b, or 2c, the data communication server 1 performs the processing shown in FIG. 4, and transmits transmission condition data that represents the condition of an optimum upload to the portable terminal that has transmitted the upload request. Accordingly, the portable terminal can perform an efficient upload.

The data communication server 1 transfers the upload data 35 collected from a plurality of portable terminals 2a, 2b, 2c, for example, to an operation system, whereby the upload data 35 can be used for an operation application.

In the example shown in FIG. 4, every time an upload request is transmitted from a certain portable terminal, the data communication server 1 gives measurement requests to all the portable terminals 2a, 2b, 2c, and collects terminal data information of the all the portable terminals 2a, 2b, 2c. However, the timing at which the terminal data of all the portable terminals 2a, 2b, 2c are collected is not limited thereto. As other methods for collecting the terminal data, for example, there are the following two methods.

According to the first method, measurement requests are given from the data communication server 1 to the portable terminals 2a, 2b, 2c for every predetermined time, and each terminal data is collected. In this case, it is preferable that the measurement requests are transmitted with a transmission time shifted for the respective portable terminals 2a, 2b, 2c so that the measurement requests are not concentrated at a particular time. Furthermore, regarding a portable terminal whose communication state is fluctuated remarkably, a measurement is made at a short interval, whereby terminal data exactly representing the communication state of the portable terminal can be obtained.

According to the second method, in the respective portable terminals 2a, 2b, 2c, in the case where a communication state is fluctuated by a certain threshold value or more from the previous terminal data transmission time, terminal data is transmitted to the data communication server 1. Because of this, the terminal data 31 in the data communication server 1 is dynamically updated in accordance with the communication state of each of the portable terminals 2a, 2b, 2c. A data transmission condition is calculated based on the terminal data 31, whereby an upload condition in accordance with the communication state is calculated.

In an example of the terminal data 31 and the priority 33 as shown in FIG. 3, only data regarding the portable terminals 2a, 2b, 2c are shown. However, portable terminals to be targeted for the terminal data 31 and the priority 33 may be previously determined, for example, to be the portable terminals 2a, 2b, 2c, or other portable terminals may be added. For example, in the case where an upload request is transmitted from a portable terminal other than the portable terminals 2a, 2b, 2c, the terminal data of that portable terminal can be added to the data shown in FIG. 3.

Furthermore, the timing at which the priority calculating part 13 calculates a priority, and the timing at which the condition generating part 14 generates transmission condition data are not limited to the example shown in FIG. 4. For example, the calculation of a priority and the generation of transmission condition data can be performed periodically on a predetermined period basis. Furthermore, in the case where the accumulation from the previous calculation of the fluctuation amount (e.g., a change amount of the transmission speed) of the communication state represented by the terminal data 31 reaches a predetermined threshold value or more, the calculation of a priority and the generation of transmission condition data can be performed. Because of this, an upload condition for controlling the data transmission from a portable terminal can be dynamically changed in accordance with the communication state with respect to the portable terminal.

Furthermore, in the example shown in FIG. 4, the priority calculating part 13 calculates priorities of all the portable terminals 2a, 2b, 2c by one calculation. However, for example, a priority can be calculated in one calculation only regarding a portable terminal that has transmitted an upload request.

Furthermore, in the example shown in FIG. 4, the condition generating part 14 generates transmission condition data regarding the portable terminal 2a among all the portable terminals 2a, 2b, 2c. However, the condition generating part 14 may calculate each transmission condition data regarding all the portable terminals 2a, 2b, 2c.

(Example of Calculation Processing of Priority)

Next, an example of the processing will be described in which the priority calculating part 13 calculates a priority of each of the portable terminals 2a, 2b, 2c based on the terminal data 31.

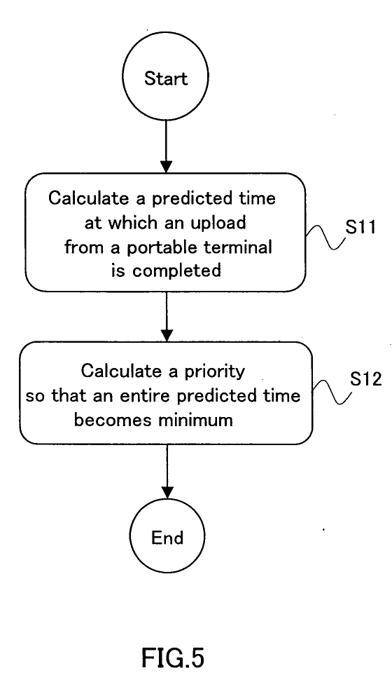

FIG. 5 is a flowchart showing an example of the processing in which the priority calculating part 13 calculates a priority. The priority calculating part 13 first calculates a predicted time taken for an upload to be completed with respect to each of the portable terminals 2a, 2b, 2c (Op 11). The predicted time is calculated, for example, by the following Expression 1 using an amount X of transmission standby data, a transmission speed B, and a radio wave intensity W contained in the terminal data 31.
X/(B·W) (1)

Herein, the radio wave intensity W is obtained by converting a radio wave intensity actually measured into a value in a range of 0 to 1. The priority calculating part 13 uses such a value of a radio wave intensity for calculating a predicted time, and estimates the transmission speed B to be lower, considering that a disconnection probability is high when the radio wave intensity is low, thereby calculating a predicted time. More specifically, the ease of disconnection of a mobile communication line is estimated from a radio wave intensity, and a predicted time considering the ease of disconnection as a communication risk can be obtained.

The connection state of a mobile communication line that changes remarkably can be modeled, considering a line disconnection risk based on the value of a radio wave intensity in a connection state. Because of this, a more appropriate priority and transmission condition data in a mobile communication line can be calculated.

The priority calculating part 13 can obtain the amount X of transmission standby data, the transmission speed B, and the radio wave intensity W, for example, from the terminal data 31 shown in FIG. 3. If a predicted time Yₐ is calculated by the above Expression 1 regarding the portable terminal 2a shown in FIG. 3, Yₐ=500 KB/(10 Mbps×0.3)≈167 μs. Similarly, Y_{b}=0 μs, Y_{c}=1600 μs.

As in the example represented by the portable terminal 2b shown in FIG. 3, regarding a portable terminal that has not given an upload request, i.e., a portable terminal whose amount of upload data in a transmission standby status is zero (0), a predicted time can be set to be 0.

A method for calculating a predicted time is not limited to the example using the above Expression 1. For example, a predicted time can be calculated by the following Expression 2, using an average transmission speed b as a transmission speed.
X/b (2)

For example, a predicted time can also be calculated by the following Expression 3, using an average delay time z and a packet loss ratio r.
(β·r)·(γ·z)·X (3)
where the packet loss ratio r is a value in a range of 0 to 1, and β and γ are coefficients.

Next, the priority calculating part 13 calculates a priority, using a predicted time (Op 12). The priority calculating part 13 calculates priorities Pₐ, P_{b}, P_{c} in the respective portable terminals so that the data transmission of the portable terminal with a longest predicted time among the portable terminals 2a, 2b, 2c is most prioritized. For example, the priority calculating part 13 may set predicted times Yₐ, Y_{b}, Y_{c} calculated in Operation 11 to be the priorities Pₐ, P_{b}, P_{c}. Consequently, the priority P_{c} of the portable terminal 2c with a longest predicted time becomes a largest value. Assuming that as the value is larger, a priority is higher, the data transmission of the portable terminal 2c has a highest priority. Furthermore, a value obtained by multiplying a predicted time by an appropriate coefficient, a value obtained by subtracting a predicted time from a predetermined constant, or the like may be set to be a priority.

As described above, the priority calculating part 13 calculates a priority considering not only the connection state between the data communication server 1 and the portable terminal 2a, but also the connection state between the data communication server 1 and the other portable terminals 2b, 2c, so as to complete the upload from the portable terminals 2a, 2b, 2c at an early stage. More specifically, the priority calculating part 13 calculates a priority so that the entire upload becomes optimum.

The priority calculating part 13 determines a portable terminal that takes longer than the other portable terminals for transmitting upload data in a transmission standby status, and calculates a priority so that the portable terminal is prioritized. More specifically, the priority calculating part 13 calculates a priority so that a portable terminal to be a bottleneck is allowed to perform an upload by priority. Consequently, the portable terminal to be a bottleneck is allowed to transmit upload data by priority. For example, a terminal with a poor connection state and a low transmission speed, and a terminal with a large amount of data required to be uploaded are prioritized. Because of this, the upload from all the portable terminals that have transmitted upload requests can be completed at an early stage.

(Example of Processing of Generating Transmission Condition Data)

Next, an example of the processing will be described in which the condition generating part 14 generates transmission condition data of each portable terminal based on the priority of each portable terminal. Herein, the case will be described in which the condition generating part 14 calculates, as transmission condition data, a transmission start time, the size of one message in the case where the upload data 35 in a transmission standby status is divided into a plurality of messages, and the transmission interval of a plurality of messages, and a connection number.

Herein, a priority Pₙ of a portable terminal n is a value of 0 or more, the priority is higher as the value is larger, and there is no upload data in a transmission standby status at a time of Pₙ=0. Therefore, the condition generating part 14 can be prevented from calculating transmission condition data.

First, a method for calculating a transmission start time will be described. If a transmission start time Tₙ (n=1, 2, 3 . . . ) of the portable terminal n is represented by an elapsed time tn from a current time T₀, the transmission start time Tₙ can be represented by the following Expression 4.
Tₙ=T₀+tₙ (4)
where tn is obtained by the following Expression 5.
tₙ=MAX(P)−Pₙ (5)

Herein, MAX(P) is a maximum value of the priorities of all the portable terminals, and Pₙ is a priority of the portable terminal n. According to the above Expression 5, a transmission start time at each portable terminal is calculated so that the transmission is started in a decreasing order of the priority. Therefore, the transmission start time of a portable terminal with a largest priority (i.e., a portable terminal to be a bottleneck) is set to be earliest.

It is preferable that the condition generating part 14 considers an upload completion predicted time T_{B} of the portable terminal to be a bottleneck, and specifies a transmission start time so that the upload from all the other portable terminals is completed before the T_{B}.

For example, in the case where the priority calculating part 13 calculates under the condition of a priority Pₙ=a predicted time Yₙ, the priority becomes a time taken for an upload. Therefore, the priority calculating part 13 calculates a transmission start time Tₙ so that the transmission completion time of all the portable terminals becomes T_{B} by Expressions 4 and 5.

Herein, the case where there are portable terminals 1 to 4 will be exemplified, with n being 1 to 4. It is assumed that the priorities of the portable terminals 1 to 4 are P₁ to P₄, respectively, and the priorities P₁ to P₄ are equal to Y₁ to Y₄. Furthermore, it is assumed that the predicted time of the portable terminal 4 is longest, and MAX(P)=P₄.

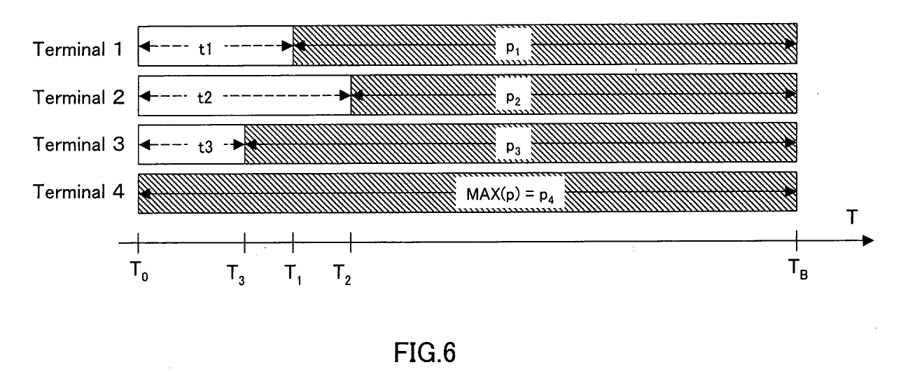

FIG. 6 schematically shows times t₁ to t₄ from a current time T₀ to a transmission start in the portable terminals 1 to 4, and processing predicted times P₁ to P₄ (=Y₁ to Y₄). The time t1 up to the transmission start of the portable terminal 1 shown in FIG. 6 is t₁=MAX(P)−P₁ in accordance with the above Expression 5. Similarly, t₂=MAX(P)−P₂, t₃=MAX(P)−P₃, t₄=MAX(P)−P₄=0. As shown in FIG. 6, the upload of the portable terminals 1 to 4 is completed at a time T_{B}=T₀+P₄ after the upload predicted time of the portable terminal 4 from the current time T₀.

Next, an example of the processing will be described in which the condition generating part 14 calculates a size k of one message in the case of dividing the upload data 35 in a transmission standby status into a plurality of messages. Assuming that the size of upload data in a transmission standby status of the portable terminal n is Sₙ, a size kₙ of one message in the portable terminal n is obtained by the following Expression 6. In the following Expression 6, CEIL(X) is a function for obtaining a minimum integer value that does not fall below X. More specifically, CEIL(X) is a function for rounding up X to an integer.
Kₙ=CEIL(Sₙ/dₙ) (6)
where dₙ=CEIL(MAX(P)/Pₙ), which is a value representing how many messages upload data in a transmission standby status should be divided into.

Next, an example of the processing will be described in which a transmission interval u of a plurality of messages is calculated in the case where the condition generating part 14 divides the upload data 35 in a transmission standby status into a plurality of messages. A transmission interval uₙ in the portable terminal n is calculated by, for example, the following Expression 7.
uₙ=MAX(P)−Pₙ (7)

Regarding the portable terminal having a maximum priority Pₙ (Pₙ=MAX(P)), the transmission interval uₙ becomes zero (0).

Next, an example of the processing will be described in which the condition generating part 14 calculates a connection number c. The connection number c is the number of connections established simultaneously between a portable terminal and the data communication server, for example, when upload data in a transmission standby status is transmitted from the portable terminal to the data communication server. A connection number cₙ in the portable terminal n is calculated by, for example, the following Expression 8.
cₙ=α·(Pₙ/MAX(P)) (8)
Herein, α is a coefficient. The connection number cₙ is calculated by the above Expression 8 so that the connection number established simultaneously is larger as the priority is higher. Basically, upload data is transmitted from a portable terminal to the data communication server 1 with one connection. However, in the case where there is a sufficient room for a connection state, and a plurality of upload data are required to be transmitted in parallel, it is preferable that the upload data are transmitted using a plurality of connections.

As the example of the method for calculating transmission condition data, a method for calculating a transmission start time, a transmission interval, the size of one message after division, and a connection number has been described above. However, the method for calculating transmission condition data is not limited thereto.

The idea of prioritizing a portable terminal that takes much time for an upload in the present embodiment is obtained by applying the idea of theory of constraints (TOC) in a production scheduling field. The time taken for the upload from all the portable terminals depends upon only a portable terminal that takes much time for an upload. Therefore, even if the upload of the other portable terminals is suppressed, the time taken for the upload from all the portable terminals does not change. Therefore, in order to complete the upload from all the portable terminals early, it is important not to hinder the upload of the portable terminal that takes much time for an upload, even by suppressing the upload of the other portable terminals.

More specifically, the data communication server 1 according to the present embodiment prioritizes an upload by a portable terminal that takes a long time for an upload, thereby enabling uploads from all the portable terminals to be completed early.

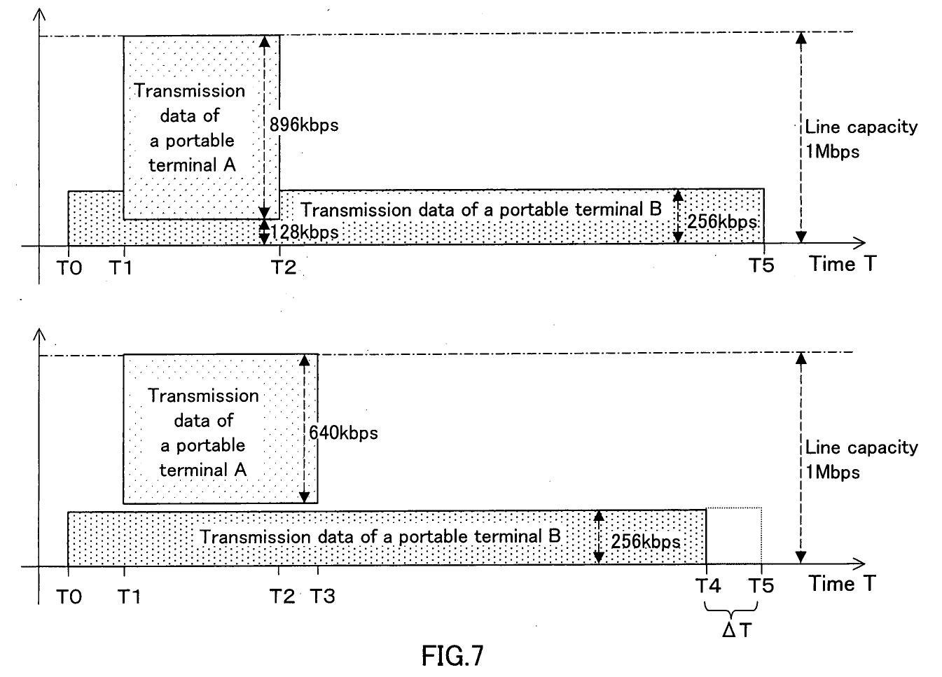

FIG. 7 is a diagram illustrating an example of the effect by the data communication server 1. In two upper and lower graphs shown in FIG. 7, a horizontal axis represents a time T, and a vertical axis represents a bandwidth used between a portable terminal and the data communication server 1. In FIG. 7, the upper graph shows an example of a change in a use bandwidth in the portable terminals A and B with the passage of time, in the case where a conventional data communication server receives an upload without considering the entire communication state. The lower graph shows an example of a change in a use bandwidth in the portable terminals A and B with the passage of time, in the case where the data communications server 1 according to the present embodiment prioritizes an upload by a portable terminal that takes a long time for an upload.

Herein, an example will be described in which the use bandwidth in the case where the portable terminal A performs an upload using a maximum transmission ability is 896 kbps, and the use bandwidth in the case where the portable terminal B performs an upload using a maximum transmission ability is 256 kbps. The portable terminal B starts an upload from a time T0 in any of the cases in the upper and lower graphs. Furthermore, the entire line capacity that can be used for an upload is 1 Mbps.

In the above graph, the portable terminal A starts an upload from a time T1, and completes the upload at a time T2. The use bandwidth of the portable terminal A is 896 kbps. Therefore, the use bandwidth of the portable terminal B from the time T1 to the time T2 is decreased to 128 kbps. Then, the portable terminal B completes an upload at a time T5.

On the other hand, in the lower graph, the portable terminal A starts an upload from the time T1, and completes the upload at a time T3 later than the time T2. At this time, the data communication server 1 prioritizes an upload of the portable terminal B whose expected time taken for an upload is long by the above-mentioned processing. Therefore, the use bandwidth of the portable terminal A becomes 640 kbps, and the upload completion time T3 becomes later than the time T2. Furthermore, the portable terminal B can perform an upload using a maximum transmission ability (at a use bandwidth of 256 kbps). As a result, the portable terminal B can complete the upload at a time T4 earlier than a time T5. Thus, in the example of the lower graph, due to the function of the data communication server 1, the uploads of all the portable terminals A and B are completed earlier by ΔT (=T5−T4), compared with the case of the upper graph.

In the present embodiment, the transmission of upload data from a portable terminal to the data communication server has been described. However, the present invention is also applicable to the processing other than the upload processing. For example, the present invention is also applicable to the case where data is downloaded or distributed from the data communication server to the portable terminal.

The present invention can be used as a data transmission system and a portable terminal that enable efficient data transmission in accordance with the communication state between a plurality of portable terminals and the data communication server.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A data communication server capable of communicating data with a plurality of portable terminals through a communication line, comprising:
a terminal information acquiring part for acquiring terminal data that represents an amount of transmission or reception standby data and a data transmission efficiency with respect to the data communication server, regarding each of the plurality of portable terminals;
a priority calculating part for obtaining a predicted time taken for the transmission or reception standby data to be transmitted or received, with respect to each of the plurality of portable terminals, using the amount of the transmission or reception standby data and the data transmission efficiency, and calculating a priority of data transmission in each of the plurality of portable terminals, using the predicted times of the plurality of portable terminals;
a condition generating part for generating transmission condition data that represents a period of time of data transmission and a transmission data amount between at least one of the plurality of portable terminals and the data communication server, based on the priority; and
a data transmitting part for transmitting the transmission standby data to a portable terminal or receiving the reception standby data from the portable terminal, based on the transmission condition data.

2. The data communication server according to claim 1, wherein the priority calculating part calculates a priority so as to most prioritize data transmission of a portable terminal with a longest predicted time among the plurality of portable terminals.

3. The data communication server according to claim 1, wherein the terminal information acquiring part acquires terminal data containing data that represents a radio wave intensity of a portable terminal, and
the priority calculating part obtains the predicted time, further using the radio wave intensity.

4. The data communication server according to claim 1, wherein the terminal information acquiring part acquires the terminal data, in a case where the amount of the transmission or reception standby data or the data transmission efficiency changes by a predetermined amount compared with that at a previous acquisition in a portable terminal.

5. A portable terminal capable of communicating data with the data communication server of any one of claims 1 to 4 through a communication line, comprising:
a terminal information transmitting part for transmitting terminal data that represents an amount of transmission standby data from the portable terminal and a data transmission efficiency with respect to the data communication server, to the data communication server;
a condition receiving part for receiving transmission condition data that represents a period of time of data transmission and a data transmission amount with respect to the data communication server, from the data communication server; and
a data transmitting part for transmitting the transmission standby data to the data communication server, based on the transmission condition data.

6. A data communication method for a data communication server to transmit/receive data with respect to a plurality of portable terminals through a communication line, comprising:
an operation in which a terminal information acquiring part of the data communication server acquires terminal data that represents an amount of transmission or reception standby data and a data transmission efficiency with respect to the data communication server, regarding each of the plurality of portable terminals;
an operation in which a priority calculating part of the data communication server obtains a predicted time taken for the transmission or reception standby data to be transmitted or received, with respect to each of the plurality of portable terminals, using the amount of the transmission or reception standby data and the data transmission efficiency, and calculates a priority of data transmission in each of the plurality of portable terminals, using the predicted times of the plurality of portable terminals;
an operation in which a condition generating part of the data communication server to generate transmission condition data that represents a period of time of data transmission and a data transmission amount between at least one of the plurality of portable terminals and the data communication server, based on the priority; and
an operation in which a data transmitting part of the data communication server transmits the transmission standby data to a portable terminal or receives the reception standby data from the portable terminal, based on the transmission condition data.

7. A program stored in a recording medium for causing a computer to execute processing of generating a condition when a data communication server transmits/receives data with respect to a plurality of portable terminals through a communication line, the processing comprising:
terminal information acquiring processing of acquiring terminal data that represents an amount of transmission or reception standby data and a data transmission efficiency with respect to the data communication server, regarding each of the plurality of portable terminals;
priority calculating processing of obtaining a predicted time taken for the transmission or reception standby data to be transmitted or received, with respect to each of the plurality of portable terminals, using the amount of the transmission or reception standby data and the data transmission efficiency, and calculating a priority of data transmission in each of the plurality of portable terminals, using the predicted times of the plurality of portable terminals; and
condition generating processing of generating transmission condition data that represents a period of time of data transmission and a data transmission amount between at least one of the plurality of portable terminals and the data communication server, based on the priority.
